(19) United States
(12) Patent Application Publication
(10) Pub. No.: US 2015/0136738 A1
(43) Pub. Date: May 21, 2015

(54) METHOD OF PROCESSING A BODY OF POLYCRYSTALLINE DIAMOND MATERIAL

(71) Applicant: Element Six Abrasives S.A., Luxembourg (LU)

(72) Inventors: Nokuthula Princess Ndlovu, Springs (ZA); Humphrey Lungisani Sithebe, Springs (ZA)

(73) Assignee: Element Six Abrasives S.A., Luxembourg (LU)

(21) Appl. No.: 14/368,698

(22) PCT Filed: Dec. 20, 2012
(86) PCT No.: PCT/EP2012/076514

§ 371 Date: Jun. 25, 2014

Related U.S. Application Data
(60) Provisional application No. 61/581,200, filed on Dec. 29, 2011.

(30) Foreign Application Priority Data
Dec. 29, 2011 (GB) 1122415.1

(51) Int. Cl. C04B 35/52; C23F 4/04

(52) U.S. Cl. CPC C04B 35/52; C23F 4/04; C04B 2235/725; C04B 2235/9607
USPC 216/109; 216/108

(57) ABSTRACT

A method of processing a polycrystalline diamond (PCD) material having a non-diamond phase comprising a diamond catalyst/solvent and/or one or more metal carbides, comprises leaching an amount of the diamond catalyst/solvent and/or one or more metal carbides from the PCD material by exposing at least a portion of the PCD material to a leaching solution. The leaching solution comprises nitric acid diluted in water, wherein the nitric acid is between around 2 to 5 wt % in the nitric acid and water mixture, and one or more additional mineral acids.

### FIELD

This disclosure relates to a method of processing a body of polycrystalline diamond (PCD) material and to a mixture for said processing.

### BACKGROUND

Cutter inserts for machining and other tools may comprise a layer of polycrystalline diamond (PCD) bonded to a cemented carbide substrate. PCD is an example of a superhard material, also called superabrasive material, which has a hardness value substantially greater than that of cemented tungsten carbide.

Components comprising PCD are used in a wide variety of tools for cutting, machining, drilling or degrading hard or abrasive materials such as rock, metal, ceramics, composites and wood-containing materials. PCD comprises a mass of substantially inter-grown diamond grains forming a skeletal mass, which defines interstices between the diamond grains. PCD material comprises at least about 80 volume % of diamond and may be made by subjecting an aggregated mass of diamond grains to an ultra-high pressure of greater than about 5 GPa, typically about 5.5 GPa, and temperature of at least about 1200° C., typically about 1440° C., in the presence of a sintering aid, also referred to as a catalyst material for diamond. Catalyst material for diamond is understood to be material that is capable of promoting direct inter-growth of diamond grains at a pressure and temperature condition at which diamond is thermodynamically more stable than graphite.

Examples of catalyst materials for diamond are cobalt, iron, nickel and certain alloys including alloys of any of these elements. PCD may be formed on a cobalt-cemented tungsten carbide substrate, which may provide a source of cobalt catalyst material for the PCD. During sintering of the body of PCD material, a constituent of the cemented-carbide substrate, such as cobalt from a cobalt-cemented tungsten carbide substrate, liquefies and sweeps from a region adjacent the volume of diamond particles into interstitial regions between the diamond particles. In this example, the cobalt acts as a catalyst to facilitate the formation of bonded diamond grains. Optionally, a metal-solvent catalyst may be mixed with diamond particles prior to subjecting the diamond particles and substrate to the HPHT process. The interstices within PCD material may at least partly be filled with the catalyst material. The intergrown diamond structure therefore comprises original diamond grains as well as a newly precipitated or re-grown diamond phase, which bridges the original grains. In the final sintered structure, catalyst/solvent material generally remains present within at least some of the interstices that exist between the sintered diamond grains.

The sintered PCD has sufficient wear resistance and hardness for use in aggressive wear, cutting and drilling applications.

A well-known problem experienced with this type of PCD compact, however, is that the residual presence of solvent/catalyst material in the microstructural interstices has a detrimental effect on the performance of the compact at high temperatures as it is believed that the presence of the solvent/catalyst in the diamond table reduces the thermal stability of the diamond table at these elevated temperatures. For example, the difference in thermal expansion coefficient between the diamond grains and the solvent/catalyst is believed to lead to chipping or cracking in the PCD table of a cutting element during drilling or cutting operations. The chipping or cracking in the PCD table may degrade the mechanical properties of the cutting element or lead to failure of the cutting element. Additionally, at high temperatures, diamond grains may undergo a chemical breakdown or back-conversion with the solvent/catalyst. At extremely high temperatures, portions of diamond grains may transform to carbon monoxide, carbon dioxide, graphite, or combinations thereof, thereby degrading the mechanical properties of the PCD material.

A potential solution to these problems is to remove the catalyst/solvent or binder phase from the PCD material.

Chemical leaching is often used to remove metal-solvent catalysts, such as cobalt, from interstitial regions of a body of PCD material, such as from regions adjacent to the working surfaces of the PCD. Conventional chemical leaching techniques often involve the use of highly concentrated, toxic, and/or corrosive solutions, such as aqua regia and mixtures including hydrofluoric acid (HF), to dissolve and remove metallic-solvent/catalysts from polycrystalline diamond materials. As such mixtures are highly toxic, the use of these carry severe health and safety risks and therefore processes for treating PCD with such mixtures must be carried out by specialised personnel under well-controlled and monitored conditions to minimise the risk of injury to the operators of such processes.

Furthermore, it is typically extremely difficult and time consuming to remove effectively the bulk of a metallic catalyst/solvent from a PCD table, particularly from the thicker PCD tables required by current applications and those containing additions to the diamond table such as carbide additions which are in addition to the non-diamond phase introduced into the PCD from the substrate to improve wear resistance, oxidation resistance and thermal stability. In general, the current art is focussed on achieving PCD of high diamond density and commensurately PCD that has an extremely fine distribution of metal catalyst/solvent pools. This fine network resists penetration by the leaching agents, such that residual catalyst/solvent often remains behind in the leached compact. Furthermore, achieving appreciable leaching depths can take so long as to be commercially unfeasible or require undesirable interventions such as extreme acid treatment or physical drilling of the PCD tables.

There is therefore a need to overcome or substantially ameliorate the above-mentioned problems through a technique for treating or processing a body of PCD material.

### SUMMARY

Viewed from a first aspect there is provided a A method of processing a polycrystalline diamond (PCD) material having a non-diamond phase comprising a diamond catalyst/solvent and/or one or more metal carbides, the method comprising leaching an amount of the diamond catalyst/solvent and/or one or more metal carbides from the PCD material by exposing at least a portion of the PCD material to a leaching solution, the leaching solution comprising nitric acid diluted in water, wherein the nitric acid comprises between around 2 to 5 wt % in the nitric acid and water mixture, and one or more additional mineral acids.

In some embodiments, the one or more additional mineral acids in the mixture comprise one or more of hydrochloric acid, sulphuric acid, phosphoric acid and hydrofluoric acid.

The leaching solution may comprise, for example, one or more additional mineral acids at a molar concentration of up to around 7M and nitric acid at a molar concentration of up to around 1.3 M.

The method may further comprise heating the leaching solution to a temperature equal to or greater than the boiling temperature of the leaching mixture during the step of exposing the PCD material to the leaching mixture.

In some embodiments, the method may comprise leaching one or more of a carbide of tungsten, titanium, niobium, tantalum, zirconium, molybdenum, chromium, or vanadium from the PCD material.

### BRIEF DESCRIPTION OF THE DRAWINGS

Various embodiments will now be described in more detail, by way of example only, with reference to the accompanying figures in which:

FIG. 1 is a schematic perspective view of a PCD cutter insert for a cutting drill bit for boring into the earth; and

FIG. 2 is a schematic cross section view of the PCD cutter insert of FIG. 1 together with a schematic expanded view showing the microstructure of the PCD material;

The same reference numbers refer to the same respective features in all drawings.

### DETAILED DESCRIPTION OF EMBODIMENTS

As used herein, “PCD material” is a material that comprises a mass of diamond grains, a substantial portion of which are directly inter-bonded with each other and in which the content of diamond is at least about 80 volume % of the material. In one embodiment of PCD material, interstices among the diamond gains may be at least partly filled with a binder material comprising a catalyst for diamond and/or a non-diamond phase.

As used herein, “catalyst material for diamond” is a material that is capable of promoting the growth of diamond or the direct diamond-to-diamond inter-growth between diamond grains at a pressure and temperature at which diamond is thermodynamically more stable than diamond.

The term “molar concentration” as used herein, refers to a concentration in units of mol/L at a temperature of approximately 25[deg.] C. For example, a solution comprising solute A at a molar concentration of 1 M comprises 1 mol of solute A per litre of solution.

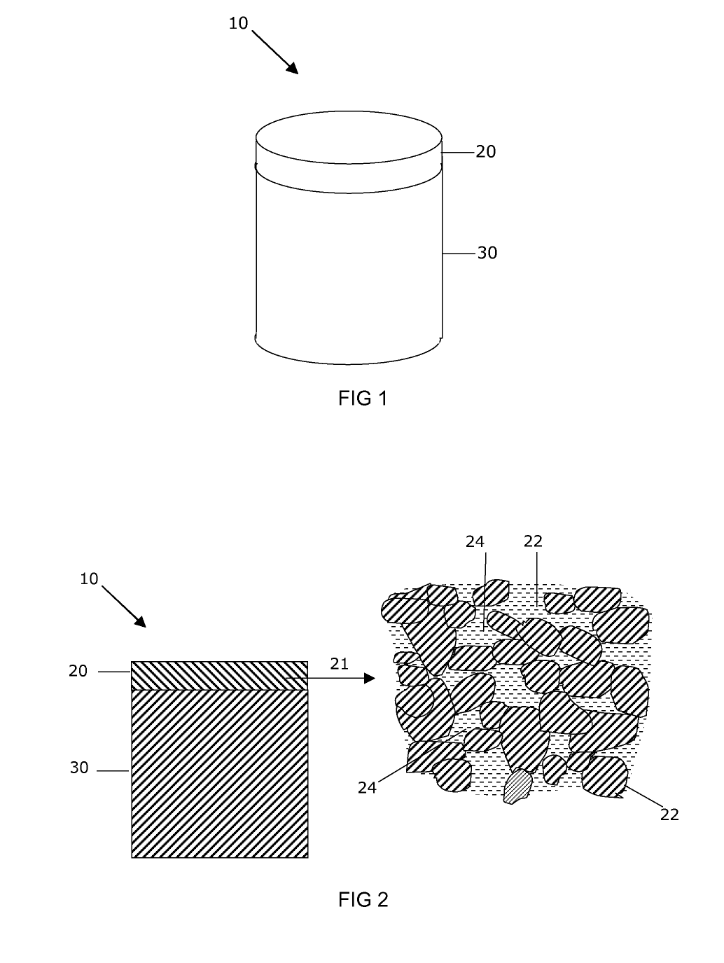

FIG. 1 shows a PCD cutter insert 10 for a drill bit (not shown) for boring into the earth, comprising a PCD body 20 bonded to a cemented tungsten carbide substrate 30.

FIG. 2 is a cross-section through the PCD cutter insert 10 of FIG. 1. The microstructure 21 of the PCD body 20 is also shown and comprises a skeletal mass of inter-bonded diamond grains 22 defining interstices 24 between the diamond grains, the interstices 24 being at least partly filled with a filler material comprising, for example, cobalt, nickel or iron. The filler material in the interstices 24 may also or in place of contain one or more other non-diamond phase additions such as for example, Titanium, Tungsten, Niobium, Tantalum, Zirconium, Molybdenum, Chromium, or Vanadium, the content of one or more of these within the filler material being, for example about 1 weight % of the filler material in the case of Ti, and, in the case of V, the content of V within the filler material being about 2 weight % of the filler material, and, in the case of W, the content of W within the filler material being about 20 weight % of the filler material.

PCT application publication number WO2008/096314 discloses a method of coating diamond particles, which has opened the way for a host of unique polycrystalline ultrahard abrasive elements or composites, including polycrystalline ultrahard abrasive elements comprising diamond in a matrix selected from materials selected from a group including VN, VC, HfC, NbC, TaC, Mo₂C, WC. PCT application publication number WO2011/141898 also discloses PCD and methods of forming PCD containing additions such as vanadium carbide to improve, inter alia, wear resistance.

Whilst wishing not to be bound by any particular theory, the combination of metal additives within the filler material may be considered to have the effect of better dispersing the energy of cracks arising and propagating within the PCD material in use, resulting in altered wear behaviour of the PCD material and enhanced resistance to impact and fracture, and consequently extended working life in some applications.

In accordance with embodiments of the method, a sintered body of PCD material is created having diamond to diamond bonding and having a second phase comprising catalyst/solvent and WC (tungsten carbide) dispersed through its microstructure together with or instead of a further non-diamond phase carbide such as VC. The body of PCD material may be formed according to standard methods, for example as described in PCT application publication number WO2011/141898, using HpHT conditions to produce a sintered PCD table. The PCD tables to be leached by embodiments of the method typically, but not exclusively, have a thickness of about 1.5 mm to about 3.0 mm.

It has been found that the removal of non-binder phase from within the PCD table, conventionally referred to as leaching, is desirable in various applications, for example, where it is desired to reattach the polycrystalline diamond disk to a carbide post, which is typically accompanied by re-infiltration of, for example, a binder material in order for such re-attachment to be successful. The carbide grains can potentially block the pathways along which re-infiltration occurs. These blockages prevent the complete re-infiltration of the binder material during the reattachment cycle, which in turn has deleterious consequences for the reattachment process.

Also, the residual presence of solvent/catalyst material in the microstructural interstices is believed to have a detrimental effect on the performance of PCD compacts at high temperatures as it is believed that the presence of the solvent/catalyst in the diamond table reduces the thermal stability of the diamond table at these elevated temperatures.

The reaction rate regarding leaching is considered to be dominated by the chemical rate initially as acid contacts a surface of the PCD table and later by the diffusion rate as the acid diffuses through the pores of the PCD table.

Conventionally, HF—HNO₃ has been shown to be the most effective media for the removal of tungsten carbide (WC) from the sintered PCD table. The problem with HF—HNO₃ is that it is volatile and, when heating this acid, specific technology, for example, gas sealing technology, is required. If such technology is not provided then the application of temperature will reduce the efficacy of HF—HNO₃ due to evaporation of the HF (which is poisonous) and formation of NO species, which are usually gaseous, and thus frequent replenishment of the acid media is required. Furthermore, as outlined above heat would ordinarily be required to accelerate the leaching process in order to render the process commercially feasible. Another problem is that HF—HNO₃ is corrosive to most containment vessels making the reaction difficult to perform.

HCl and other similar mineral acids are easier to work with at high temperatures than HF—HNO₃ and are aggressive towards the catalyst/solvent, particularly cobalt (Co). HCl, for example, may remove the bulk of the catalyst/solvent from the PCD table in a reasonable time period, depending on the temperature, typically in the region of 80 hours, although it does not remove WC and it has been appreciated by the present applicant that HCl alone is not suitable for removing the non-diamond phase additions, such as VC from the PCD table.

To improve the performance and heat resistance of a surface of the body of PCD material 20, at least a portion of the metal-solvent catalyst, such as cobalt, and at least a portion of the additions to the PCD, such as carbide additions, may be removed from the interstices 22 of at least a portion of the PCD material 20. Additionally, tungsten and/or tungsten carbide may be removed from at least a portion of the body of PCD material 20.

Chemical leaching is used to remove the metal-solvent catalyst and the additions from the body of PCD material 20 either up to a desired depth from an external surface of the body of PCD material or from substantially all of the PCD material 20. Following leaching, the body of PCD material 20 may therefore comprise a first volume that is substantially free of a metal-solvent catalyst. However, small amounts of catalyst may remain within interstices that are inaccessible to the leaching process. Additionally, following leaching, the body of PCD material 20 may also comprise a volume that contains a metal-solvent catalyst. In some embodiments, this further volume may be remote from one or more exposed surfaces of the body of PCD material 20.

The interstitial material which may include, for example, the metal-solvent/catalyst and one or more additions in the form of carbide additions, may be leached from the interstices 22 in the body of PCD material 20 by exposing the PCD material to a suitable leaching solution.

According to embodiments, the leaching solution comprises one or more mineral acids in addition to diluted nitric acid. The body of PCD material may be exposed to such a leaching solution in any suitable manner, including, for example, by immersing at least a portion of the body of PCD material 20 in the leaching solution for a period of time.

According to some embodiments, the body of PCD material may be exposed to the leaching solution at an elevated temperature, for example to a temperature at which the acid leaching mixture is boiling. Exposing the body of PCD material to an elevated temperature during leaching may increase the depth to which the PCD material may be leached and reduce the leaching time necessary to reach the desired leach depth.

If only a portion of the body of PCD material is to be leached, the body, and if it is still attached to the substrate, the substrate may be at least partially surrounded by a protective layer to prevent the leaching solution from chemically damaging certain portions of the body of PCD material and/or the substrate attached thereto during leaching. Such a configuration may provide selective leaching of the body of PCD material, which may be beneficial. Following leaching, the protective layer or mask may be removed.

Additionally, in some embodiments, at least a portion of the body of PCD material and the leaching solution may be exposed to at least one of an electric current, microwave radiation, and/or ultrasonic energy to increase the rate at which the body of PCD material is leached.

Examples of suitable mineral acids may include, for example, hydrochloric acid, phosphoric acid, sulphuric acid, hydrofluoric acid, and/or any combination of the foregoing mineral acids.

In some embodiments, nitric acid may be present in the leaching mixture of some embodiments in an amount of, for example, between 2 to 5 wt % and/or a molar concentration of up to around 1.3M. In some embodiments, one or more mineral acids may be present in the leaching solution at a molar concentration of up to around, for example, 7M.

Some embodiments are described in more detail with reference to the following examples which are not intended to be limiting. The following examples provide further detail in connection with the embodiments described above.

### Example 1

Cutting elements, each comprising a PCD table attached to a tungsten carbide substrate, were formed by HPHT sintering of diamond particles having an average grain size of about 10 microns in the presence of cobalt. The sintered-polycrystalline-diamond tables included cobalt and tungsten within the interstitial regions between the bonded diamond grains together with 3 wt % vanadium carbide.

The PCD table was leached using a solution comprising 6.9 M hydrochloric acid, and 1.13 M nitric acid diluted in water. The PCD table was leached for 30 hours at a temperature at which the acid leaching mixture was boiling and ultrasound was applied after a period of leaching to remove remnant reactants.

After leaching, leached depths of the PCD table were determined for various portions of the PCD table, through x-ray analysis.

The resultant leach depths achieved are shown below in Table 1 for Example 1 and the following examples. In example 1, the average leach depth achieved using the aforementioned leaching mixture over a period of 30 hours was 144 microns.

### Example 2

Cutting elements, each comprising a PCD table attached to a tungsten carbide substrate, were formed by HPHT sintering of diamond particles having an average grain size of about 10 microns in the presence of cobalt. The sintered-polycrystalline-diamond tables included cobalt and tungsten within the interstitial regions between the bonded diamond grains together with 3 wt % vanadium carbide.

The PCD table was leached using a solution comprising 6.9 M hydrochloric acid, and 1.13 M nitric acid diluted in water. The PCD table was leached for 30 hours at a temperature at which the acid leaching mixture was boiling.

After leaching, leached depths of the PCD table at various points were determined for various portions of the PCD table, through x-ray analysis.

The average leach depth achieved using the aforementioned leaching mixture over a period of 30 hours was 161 microns.

### Example 3

Cutting elements, each comprising a PCD table attached to a tungsten carbide substrate, were formed by HPHT sintering of diamond particles having an average grain size of about 10 microns in the presence of cobalt. The sintered-polycrystalline-diamond tables included cobalt and tungsten within the interstitial regions between the bonded diamond grains together with 3 wt % vanadium carbide.

The PCD tables were leached using a solution comprising 6.9 M hydrochloric acid, and 0.36 M nitric acid diluted in water. The PCD tables were leached for 10 hours at a temperature at which the acid leaching mixture was boiling.

After leaching, leached depths of the PCD tables at various points were determined for various portions of the PCD table, through x-ray analysis.

The average leach depth achieved using the aforementioned leaching mixture over a period of 10 hours was 202 microns for some tables and an average leach depth of 211.5 microns was achieved for other PCD tables.

### Example 4

Cutting elements, each comprising a PCD table attached to a tungsten carbide substrate, were formed by HPHT sintering of diamond particles having an average grain size of about 10 microns in the presence of cobalt. The sintered-polycrystalline-diamond tables included cobalt and tungsten within the interstitial regions between the bonded diamond grains together with 3 wt % vanadium carbide.

The PCD tables were leached using a solution comprising around 7M hydrochloric acid (for example 6.9 M), and 0.59 M nitric acid diluted in water. The PCD tables were leached for 10 hours at a temperature at which the acid leaching mixture was boiling.

After leaching, leached depths of the PCD tables at various points were determined for various portions of the PCD tables, through x-ray analysis.

In some cutters, the average leach depth achieved using the aforementioned leaching mixture over a period of 10 hours was 139.5 microns and in others a leach depth of 218.5 microns was achieved.

### Example 5

Cutting elements, each comprising a PCD table attached to a tungsten carbide substrate, were formed by HPHT sintering of diamond particles having an average grain size of about 10 microns in the presence of cobalt. The sintered-polycrystalline-diamond tables included cobalt and tungsten within the interstitial regions between the bonded diamond grains together with 3 wt % vanadium carbide.

The PCD table was leached using a solution comprising around 7M hydrochloric acid, for example 6.9M, and 0.24 M nitric acid diluted in water. The PCD table was leached for 10 hours at a temperature at which the acid leaching mixture was boiling.

After leaching, leached depths of the PCD table at various points were determined for various portions of the PCD table, through x-ray analysis.

The average leach depth achieved using the aforementioned leaching mixture over a period of 10 hours was 153 microns.

TABLE 1

| | Molar | Molar | | | |
|---|---|---|---|---|---|
| | concen- | concen- | Leach depth (microns) | | |
| PCD and leaching | tration | tration | Side | Side | |
| composition | HCl | HNO₃ | a | b | Average |
| PCD + 3 wt % VC leached in | 6.9 | 1.13 | 97 | 191 | 144 |
| HCl/H2O/HNO3 (10 wt %) | | | | | |
| 30 hrs heat and ultrasound | | | | | |
| PCD + 3 wt % VC leached | 6.9 | 1.13 | 172 | 150 | 161 |
| in HCl/H2O/HNO3 (10 wt%) | | | | | |
| 30 hrs heat | | | | | |
| PCD + 3 wt % VC leached | 6.9 | 0.36 | 196 | 208 | 202 |
| in HCl/H2O/HNO3 (3 wt %) | | | | | |
| 10 hrs | | | | | |
| PCD + 3 wt % VC leached | 6.9 | 0.59 | 143 | 136 | 139.5 |
| in HCl/H2O/HNO3 (5 wt %) | | | | | |
| 10 hrs | | | | | |
| PCD + 3 wt % VC leached | 6.9 | 0.36 | 223 | 200 | 211.5 |
| in HCl/H2O/HNO3 (3 wt%) | | | | | |
| 10 hrs | | | | | |
| PCD + 3 wt % VC leached | 6.9 | 0.59 | 226 | 211 | 218.5 |
| in HCl/H2O/HNO3 (5 wt%) | | | | | |
| 10 hrs | | | | | |
| PCD + 3 wt % VC leached | 6.9 | 0.24 | 170 | 136 | 153 |
| in HCl/H2O/HNO3 (2 wt%) | | | | | |
| 10 hrs | | | | | |

When compared with the leach depths achievable using conventional leaching solutions, it has been determined that the embodiments including the above leaching mixtures may enable a greater leaching efficiency to be achieved with greater leach depths being achievable in a shorter period of time. Furthermore, the nature of the components forming the acid leaching mixture of embodiments also enable carbide additions to be leached from the PCD material, in addition to conventional binder-solvent present in the PCD. Also, health and safety handling issues are reduced as the acid leaching mixture is less toxic than other conventional HF-nitric based leaching mixtures.

The preceding description has been provided to enable others skilled the art to best utilize various aspects of the embodiments described by way of example herein. This description is not intended to be exhaustive or to be limited to any precise form disclosed. Many modifications and variations are possible. In particular, whilst the method has been described as being particularly effective in leaching PCD containing VC additives, it is equally applicable to the effective leaching of PCD with other additives such as those in the form of other metal carbides including one or more of a carbide of tungsten, titanium, niobium, tantalum, zirconium, molybdenum, or chromium.

1. A method of processing a polycrystalline diamond (PCD) material having a non-diamond phase comprising a diamond catalyst/solvent and/or one or more metal carbides, the method comprising leaching an amount of the diamond catalyst/solvent and/or one or more metal carbides from the PCD material by exposing at least a portion of the PCD material to a leaching solution, the leaching solution comprising nitric acid diluted in water, wherein the nitric acid comprises between around 2 to 5 wt % in the nitric acid and water mixture, and one or more additional mineral acids.

2. The method of claim 1, wherein the one or more additional mineral acids comprise one or more of hydrochloric acid, sulphuric acid, phosphoric acid and hydrofluoric acid.

3. The method of claim 1, wherein the leaching solution comprises the one or more additional mineral acids at a molar concentration of up to around 7M.

4. The method of claim 1, wherein the leaching solution comprises the one or more additional mineral acids at a molar concentration of around 7M.

5. The method of claim 1, wherein the leaching solution comprises nitric acid at a molar concentration of up to around 1.3 M.

6. The method of claim 1, wherein the leaching solution comprises nitric acid at a molar concentration of between around 0.2 M to around 1.2 M.

7. The method of claim 1, further comprising heating the leaching solution to a temperature equal to or greater than the boiling temperature of the leaching mixture during the step of exposing the PCD material to the leaching mixture.

8. The method of claim 1, wherein the metal-solvent catalyst comprises at least one of: cobalt; nickel; iron.

9. The method according to claim 1, wherein the PCD table has a thickness of from about 1.5 mm to about 3.0 mm.

10. The method of claim 1 wherein the step of leaching comprises leaching one or more of a carbide of tungsten, titanium, niobium, tantalum, zirconium, molybdenum, chromium, or vanadium from the PCD material.

11. (canceled)
